(19) United States
(12) Patent Application Publication
(10) Pub. No.: US 2016/0055609 A1
(43) Pub. Date: Feb. 25, 2016

(54) GRAPHICS PROCESSING METHOD, SYSTEM, AND APPARATUS

(71) Applicant: ADVANCED MICRO DEVICES, INC., Sunnyvale, CA (US)

(72) Inventors: Chenbin Wang, Shanghai (CN); Jian Wang, Shanghai (CN); Pingping Shao, Sunnyvale, CA (US)

(73) Assignee: ADVANCED MICRO DEVICES, INC., Sunnyvale, CA (US)

(21) Appl. No.: 14/534,505

(22) Filed: Nov. 6, 2014

(30) Foreign Application Priority Data
Aug. 25, 2014 (CN) 201410421077.6

(51) Int. Cl. G06T 1/20; G06T 1/60

(52) U.S. Cl. CPC G06T 1/20; G06T 1/60

(57) ABSTRACT

A graphics processing apparatus, system, and method is provided. The graphics processing method includes separating a graphics context and graphics object from a packet; calculating a magic number of the graphics context; comparing the magic number of the graphics context with magic numbers stored in a context table, wherein each of the magic numbers corresponds to a specific graphics context; and, if the magic number of the graphics context is not found among the magic numbers in the context table, adding the graphics context to a graphics context slot of a graphics context storage, adding the graphics object to a graphics object list separate from the graphics context storage, and associating the graphics context slot with the listed graphics object.

### CROSS REFERENCE TO RELATED APPLICATION

This application claims priority to Chinese Patent Application No. 201410421077.6, filed Aug. 25, 2014, the entire contents of which is hereby incorporated by reference as if fully set forth herein.

### TECHNICAL FIELD

The present invention relates generally to graphics processing. More specifically, the present invention relates to a method, system, and apparatus to merge contexts in graphics processing.

### BACKGROUND

Graphics contexts and objects are a fundamental part of graphics processing. In order to render graphics, generally, a Central Processing Unit (CPU) sends command packets to a Graphics Processing Unit (GPU). The command packet contains commands and objects. The command defines the graphics context, i.e., how the GPU should draw. Here, a graphics context can be thought of as a group of settings of draws. These settings usually are recorded in registers. Registers are quick memory inside a GPU, and the GPU can read/write these registers and apply the settings. The object is what a GPU should draw. The GPU will allocate resources, follow the commands, and draw the objects for display in a display device.

In existing methods of graphics processing, when a CPU sends a first command packet, the GPU will allocate resources, including memory space and registers, generate a context, its context ID and analyze the commands and objects. When the CPU sends the second packet, the GPU will do the same work. When finishing one packet, the GPU turns to the next packet. The GPU will not turn to deal with the second packet until it finishes the first packet. The GPU will repeat the work until the CPU stops sending any more command packets.

FIG. 1 shows a schematic diagram of a current GPU configured to perform the existing method of graphics processing. As shown in FIG. 1, the current GPU contains a ring buffer (RB), a read pointer and a write pointer. The RB contains some packet slots. All the command packets P0, P1, P2, etc. sent from the CPU are stored in the packet slots in the RB. The command packets contain the graphics context and graphics objects. The read pointer points to the current packet such as P0 shown in FIG. 1. The GPU will read the current packet and apply the graphics context to draw the graphics object. When the current command packet is finished, the read pointer will point to the next new packet, such as P1 shown in FIG. 1, and the GPU will read the new packet content and deal with the new packet. The write pointer points to the first empty packet slot. When the CPU sends a new command packet to the GPU, the GPU will store it in the packet slot where the write pointer is pointing. Then the write pointer will point to the next empty packet slot.

When the read pointer and the write pointer point to the same packet slot, the RB is empty. When the read pointer points to the next packet slot of the write pointer, the RB is full. If the RB is full, the GPU will stop receiving any more command packets from the CPU, until at least one packet slot in the RB is released.

### SUMMARY

In the existing apparatus and method of graphics processing, when the CPU sends a lot of command packets, significant resources and time are spent by a the GPU to allocate memory, apply the contexts, and draw the objects. In this regard, a lot of resources and time are wasted on context switching, since with respect to every context in the command packets, the GPU must make a switch.

For example, if the CPU wants to draw a mountain with lots of trees on it, every tree may have its own context. With every packet, the GPU needs to wait for the end of the current context, initialize a new environment for a new context, and draw new objects, even if the contexts are the same as each other. This wastes resources and time, since if one tree is drawn, to switch the context and draw another, it will cost time and resources on context switching, and significant resources are tied up since the GPU must constantly apply “new” contexts.

Moreover, in the existing apparatus and method of graphics processing, the RB will be full easily if the CPU sends a lot of command packets, which could reduce the work efficiency of the GPU.

To overcome the disadvantages in the current apparatus and method of graphics processing, the present invention provides a graphics processing method, system, and apparatus which can save resources and time and enhance the work efficiency of graphics processing.

In an example embodiment embodying a first aspect, a graphics processing method is provided. The graphics processing method includes separating a graphics context and graphics object from a packet; calculating a magic number of the graphics context; comparing the magic number of the graphics context with magic numbers stored in a context table, wherein the magic numbers all correspond to a specific graphics context; and, if the magic number of the graphics context is not found among the magic numbers in the context table, adding the graphics context to a graphics context slot of a graphics context storage, adding the graphics object to a graphics object list separate from the graphics context storage, and associating the graphics context slot with the listed graphics object.

In an example embodiment embodying a second aspect, a graphics processing system is provided. The system includes means for separating a graphics context and graphics object from a packet; a graphics context storage means for storing the graphics context, the graphics context storage means including graphics context slots; a graphics object storage means for storing the graphics object, the graphics object storage means being separate from the graphics context storage means; means for calculating a magic number of the graphics context to determine a calculated magic number of the graphics context; a magic number storage means for storing the magic number of the graphics context; means for comparing the calculated magic number of the graphics context with magic numbers stored in the magic number storage means to determine if the calculated magic number of the graphics context is among the magic numbers in the magic number storage means, wherein the magic numbers all correspond to a specific graphics context; and means for adding the graphics context to a graphics context slot of the graphics context storage means, adding the graphics object to the graphics object storage means, and associating the graphics context slot with the stored graphics object, if the calculated magic number of the graphics context is not among the magic numbers in the magic number storage means.

In an example embodiment embodying a third aspect, a graphics processing apparatus is provided. The apparatus includes a programmable computing unit configured to separate a graphics context and graphics object from a packet, and calculate a magic number of the graphics context; a graphics context buffer configured to store the graphics context, the graphics context buffer including graphics context slots; a graphics object list configured to store the graphics object, the graphics object list being separate from the graphics context buffer; a context table for storing magic numbers of the graphics context; means for comparing the calculated magic number of the graphics context with magic numbers stored in the context table to determine if the calculated magic number of the graphics context is among the magic numbers in the context table, wherein the magic numbers all correspond to a specific graphics context; and means for adding the graphics context to a graphics context slot of the graphics context buffer, adding the graphics object to the graphics object list, and associating the graphics context slot with the graphics object stored in the graphics object list, if the calculated magic number of the graphics context is not among the magic numbers in the context table.

Other aspects and embodiments are described herein below.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of a prior art graphics processing apparatus;

FIG. 2 shows a schematic diagram of a graphics processing apparatus according to one explanatory embodiment of the present invention;

FIG. 3 is a flow chart of the method of graphics processing according to one explanatory embodiment of the present invention;

FIG. 4 shows a flow chart of the method for reading and applying a context in a context buffer according to one explanatory embodiment of the present invention; and

FIG. 5 shows a flow chart of the method for writing a context in a context buffer according to one explanatory embodiment of the present invention.

### DETAILED DESCRIPTION

The present invention will now be described in detail with reference to a few preferred embodiments thereof as illustrated in the accompanying drawings. In the following description, numerous specific details are set forth to provide a thorough understanding of the present invention. It will be apparent, however, to one skilled in the art, that the present invention may be practiced without some or all of these specific details. In other instances, well known process steps and/or structures have not been described in detail to not unnecessarily obscure the present invention.

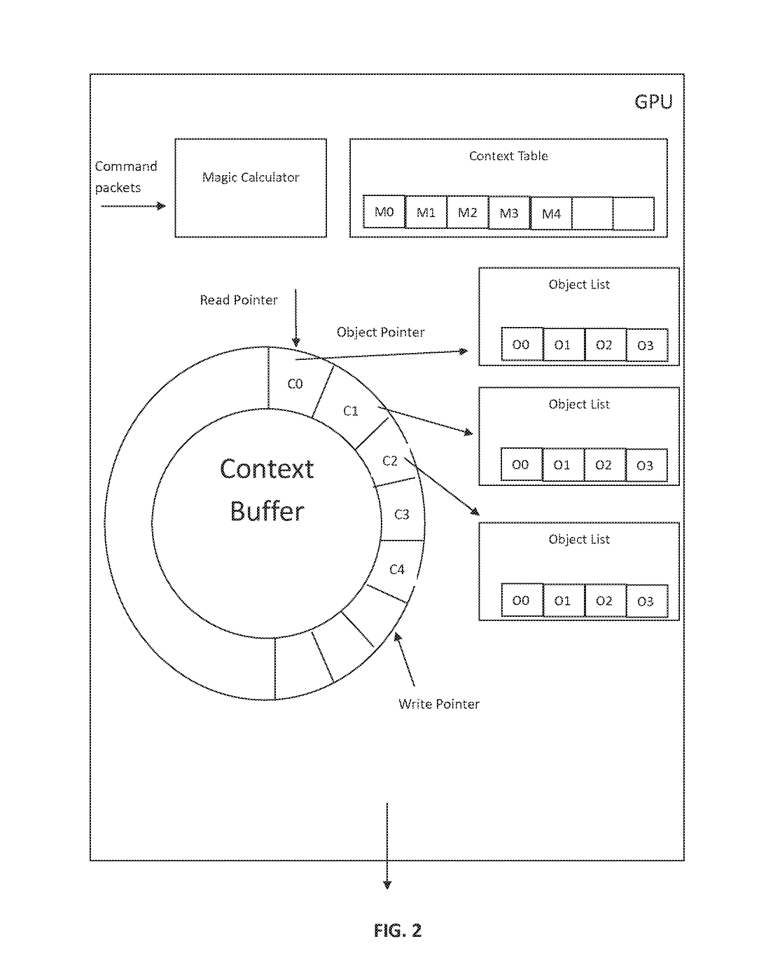

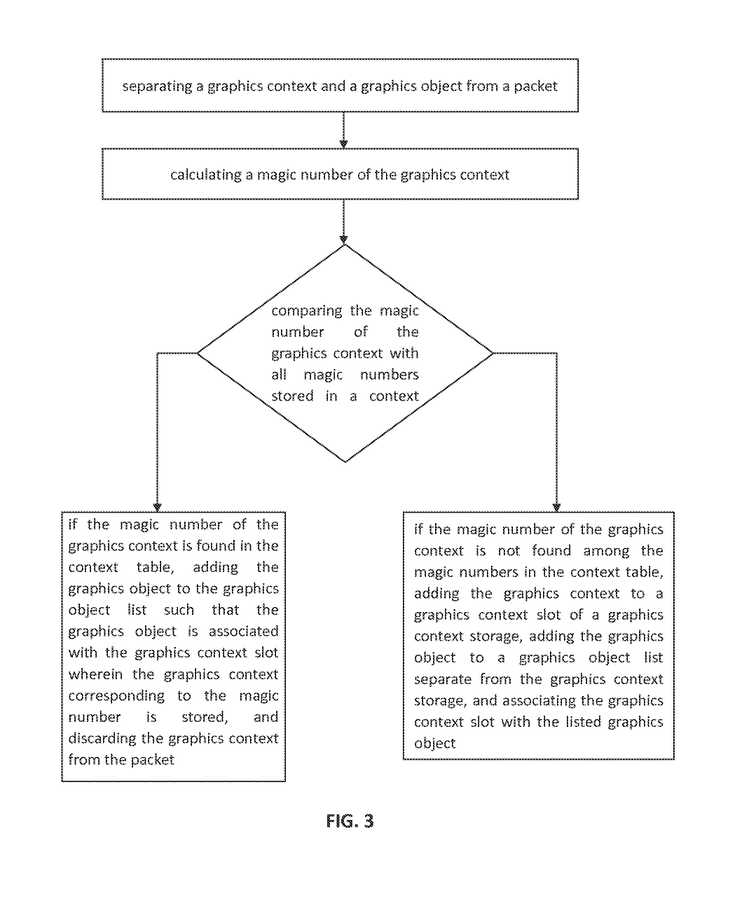

In the following, an exemplary graphics processing method, system, and apparatus of the present invention will be described in detail with reference to FIGS. 2 and 3.

As shown in FIG. 3, in a first step of the graphics processing method, when a command packet containing a graphics context and a graphics object is received, the graphics context and graphics object are separated. The command packet may be received, for example, by a GPU from a CPU via a memory bridge.

After separation of the graphics context and object, a magic number of the graphics context is calculated. This calculation can be performed, for example, by a magic calculator (MC) of a GPU as shown in FIG. 2. The magic number is an identity for identifying every graphics context. In an exemplary embodiment, the Message Digest Algorithm 5 (MD5) could be applied to calculate the magic number of the graphics context.

After the magic number of the graphics context is calculated, the magic number is compared with magic numbers stored in a magic number storage means, e.g., the context table of the GPU in FIG. 2. If the calculated magic number of the graphics context is not found among the magic numbers in the context table, the graphics context may be added to a graphics context storage means, e.g., a graphics context slot of a context buffer as depicted in FIG. 2. The graphics object, which has been separated from the graphics context, may be added to a separate graphics object storage means, e.g., a graphics object list, as shown in FIG. 2. The graphics object is then associated with the graphics context, and the calculated magic number may be added to the magic number storage means, e.g., the context table shown in FIG. 2.

If, upon comparison, the calculated magic number of a graphics context contained in a packet is found among the magic numbers stored in the magic number storage means, the graphics context may be considered to be the same as the graphics context having the same magic number, and thus the graphics context could be considered as already stored in graphics context storage means. Thus, the graphics context from the packet could be discarded, and only the graphics object contained in the same packet needs to be saved. As shown in FIG. 2, the graphics object may be stored in the graphics object storage means, e.g., a graphics object list, together with the other objects already associated with corresponding graphics context stored in the graphics context storage means. In this way, significant resources can be saved.

The operation of the above discussed graphics processing method will now be more particularly described with reference to FIG. 2.

FIG. 2 shows a schematic diagram of an exemplary embodiment of an apparatus useful for the graphics processing system and method. The apparatus of FIG. 2 is a GPU, and contains a context buffer, a read pointer, a write pointer, a context table, some object lists, some object pointers, and a magic calculator (MC).

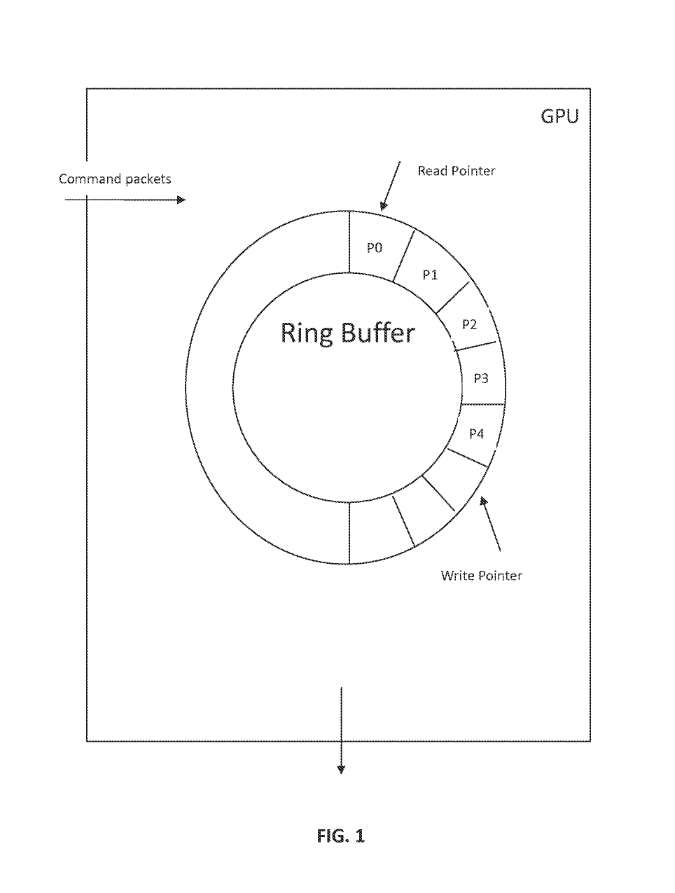

As shown in FIG. 2, the context buffer is similar to the ring buffer as shown in FIG. 1, except for the significant difference that context buffer only contains graphics contexts, and does not contain any graphics objects. Only the contexts sent from CPU, i.e., C0, C1, C2, . . . are stored in the context buffer.

Magic numbers are stored in a context table as shown in FIG. 2. Context table contains the magic numbers of all of the graphics contexts stored in the context buffer. M0 is the magic number of context C0, M1 is the magic number of context C1, M2 is the magic number of the context C2, etc. The number of graphics context slots in the context buffer is the same as the number of magic numbers in the context table.

In operation, graphics contexts and graphics objects contained in a command packet are separated when received, and the magic calculator (MC) calculates the magic number of every graphics context received in the command packet. The MC may apply, for example, the Message Digest Algorithm 5 (MD5), the MD5 code (128 bit) being the magic number of a graphics context. Then MC will compare the calculated magic number with all the current magic numbers which are stored in the context table. If the calculated magic number is not found among all the current magic numbers stored in context table, the graphics context contained in the command packet is added into the graphics context slot of context buffer where the write pointer is pointing.

In this regard, in the exemplary embodiment of FIG. 2, graphics contexts and graphics objects are associated via object pointers. Each graphics context stored in a graphics context slot of context buffer has an object pointer, which points to an object list. The object list contains graphics objects that have been separated from the graphics contexts in command packets, e.g., O0, O1, O2, O3, etc. Thus, when a graphics context is added into a graphics context slot of the context buffer, the associated graphics objects are added to an object list and associated with the graphics context in the graphics context slot via an object pointer. Also, the calculated magic number is added to the context table. The write pointer is then moved to the next available context slot in context buffer.

As mentioned above, if two graphics contexts have the same magic number, the two contexts may be considered to be the same, and thus effectively merged into one, i.e., the second received context may be discarded, and only the graphics objects retained, and the retained graphics objects may be associated with the already stored graphics context. In the exemplary embodiment of FIG. 2, if the calculated magic number of a graphics context of a command packet is found in the context table, the graphics context associated with the calculated magic number is considered to be the same as the graphics context having the same magic number that is already stored in the context buffer. The graphics objects of the command packet can be directly added to the object list pointed to by the object pointer of the graphics context slot storing the graphics context having the same magic number, and the graphics context received in the command packet may be discarded. There is no need to change any other block.

In GPU rendering, the GPU will render the objects in the object list which are pointed to by object pointers according to the corresponding graphics context stored in the graphics context slot of the context buffer. In the exemplary embodiment of FIG. 2, the GPU renders all objects in the object list which are pointed to by object pointers of the current context, which is pointed to by the read pointer. When GPU finishes rendering all the objects in the current object list, the read pointer will point to the next context slot. Then the GPU will apply the new context in the next context slot and draw new objects.

The read pointer and write pointer shown in FIG. 2 have the same function as in the current GPU shown in FIG. 1, i.e., the read pointer points to the current context, and when the current context is finished, the read pointer will point to the next context and the GPU will read the next context content and deal with the new context. The write pointer points to the first empty context slot. When a new command packet is received, GPU will store the graphics context therein in the context slot where the write pointer is pointing. Then the write pointer will point to the next empty context slot.

When the read pointer and the write pointer point to the same context slot, the context buffer is empty. When the read pointer points to the next context slot of the write pointer, the context buffer is full. If the context buffer is full, GPU will stop receiving any more command packets from CPU, until at least one graphics context slot in the context buffer is released.

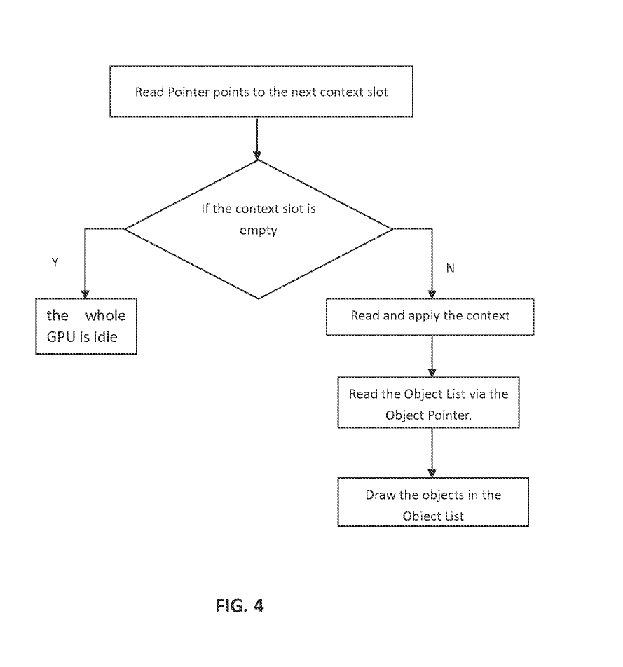

FIG. 4 shows an exemplary flow chart for reading and applying a context in context buffer. When starting a new context, the read pointer points to a new context slot, and it will read the context slot. If the write pointer points to the same context slot, the context buffer is empty. Then the whole GPU is idle, until the CPU sends a new command packet to the GPU. If the context buffer is not empty, the GPU will read and apply the new context and read the object list via the object pointer, and then draw the objects in this object list.

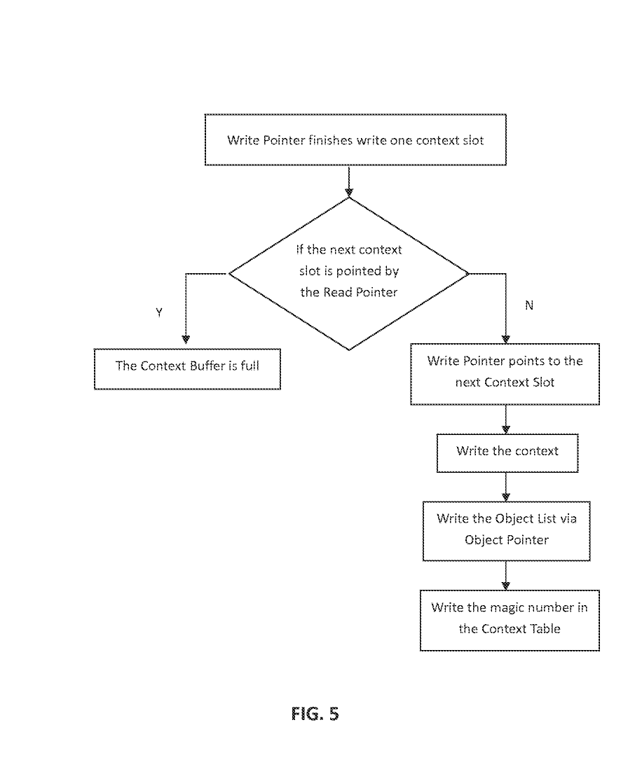

FIG. 5 shows an exemplary flow chart for writing a context in the context buffer. After finishing writing one context slot, when writing a new context, the write pointer tries to point to a new context slot, and if the new context slot is pointed at by the read pointer, the context buffer is full. Then the write pointer will stop writing the new context until the GPU finishes one context so that a context slot is released. If the context buffer is not full, the new context can be written to the graphics context slot of the context buffer that is pointed at by the write pointer, and the corresponding graphics objects can be added to an object list and associated with the graphics context slot of the context buffer via an object pointer, and the magic number of this context can be written into the context table.

As may be seen, in the apparatus, system, and method of the present invention, when graphics contexts are the same, they will be merged into one context. The GPU only needs to draw the graphics objects and does not need to switch the contexts, thus saving resources and time. Meanwhile, because contexts are merged into one context, the context buffer will not be full easily, which can also enhance the work efficiency of a GPU.

Although features and elements are described above in particular combinations, each feature or element can be used alone without the other features and elements or in various combinations with or without other features and elements. The methods or flow charts provided herein may be implemented in a computer program, software, or firmware incorporated in a non-transitory computer-readable storage medium for execution by a general purpose computer or a processor. Examples of computer-readable media include, but are not limited to, magnetic media such as hard disks, floppy disks, and magnetic tape; optical media such as CD-ROMs and holographic devices; magneto-optical media such floptical disks; and hardware devices that are specially configured to store and execute program code, such as application-specific integrated circuits (ASICs), programmable logic devices and ROM and RAM devices. The computer-readable codes can be executed by one or more processing units such as a graphics processing unit.

It will be apparent to those skilled in the art that various modifications and variations can be made to the embodiments described herein without departing from the scope of the claimed subject matter. Thus, it is intended that the specification cover the modifications and variations of the various embodiments described herein, provided such modification and variations come within the scope of the appended claims and their equivalents.

1. A graphics processing method, comprising:
separating a graphics context and graphics object from a command packet;
calculating a magic number of the graphics context, wherein the magic number is an identifier of the graphics context;
comparing the magic number of the graphics context with magic numbers stored in a context table, wherein each magic number corresponds to a specific graphics context; and
if the magic number of the graphics context is not found among the magic numbers in the context table;
adding the graphics context to a graphics context slot of a graphics context storage,
adding the graphics object to a graphics object list separate from the graphics context storage, and
associating the graphics context slot with the listed graphics object.

2. The graphics processing method of claim 1, further comprising:
if the magic number of the graphics context is found in the context table;
adding the graphics object to the graphics object list such that the graphics object is associated with the graphics context slot wherein the graphics context corresponding to the magic number is stored, and
discarding the graphics context from the packet.

3. The graphics processing method of claim 2, further comprising:
adding the magic number of the graphics context to the context table if the magic number of the graphics context is not found among the magic numbers stored in the context table.

4. The graphics processing method of claim 1, further comprising:
applying the graphics context in the graphics context slot of the graphics context storage to draw the graphics objects in the object list that are associated with the graphics context slot.

5. A graphics processing system, comprising:
a graphics processing unit (GPU), configured to separate a graphics context and graphics object from a command packet;
a context buffer, configured to store the graphics context, the context buffer including graphics context slots;
a graphics object list, configured to store the graphics object, the graphics object list being separate from the context buffer;
a calculator, configured to calculate a magic number of the graphics context, wherein the magic number is an identifier of the graphics context;
a context table for storing the magic number of the graphics context;
wherein the GPU is further configured to:
compare the magic number of the graphics context with magic numbers stored in the context table to determine if the magic number of the graphics context is among the magic numbers in the context table, wherein each magic number corresponds to a specific graphics context;
add the graphics context to a graphics context slot of the context buffer;
add the graphics object to the graphics object list; and
associate the graphics context slot with the stored graphics object, if the magic number of the graphics context is not among the magic numbers in the context table.

6. The graphics processing system of claim 5, wherein the GPU is further configured to:
add the graphics object to the graphics object list such that the graphics object is associated with the graphics context slot wherein the graphics context corresponding to the magic number is stored, and
discard the graphics context from the packet, if the magic number of the graphics context is found in the context table.

7. The graphics processing system of claim 6, wherein the GPU is further configured to:
add the magic number of the graphics context to the context table if the magic number of the graphics context is not among the magic numbers in the context table.

8. The graphics processing system of claim 5, wherein the GPU is further configured to:
apply the graphics context in the graphics context slot of the context buffer to draw the graphics objects in the graphics object list that are associated with the graphics context slot.

9-12. (canceled)

13. A non-transitory computer-readable storage medium storing a set of instructions for execution by a general purpose computer to perform a graphics processing method, the set of instructions comprising:
a separating code segment for separating a graphics context and graphics object from a command packet;
a calculating code segment for calculating a magic number of the graphics context, wherein the magic number is an identifier of the graphics context;
a comparing code segment for comparing the magic number of the graphics context with magic numbers stored in a context table, wherein each magic number corresponds to a specific graphics context; and
if the magic number of the graphics context is not found among the magic numbers in the context table:
a first adding code segment for adding the graphics context to a graphics context slot of a graphics context storage,
a second adding code segment for adding the graphics object to a graphics object list separate from the graphics context storage, and
an associating code segment for associating the graphics context slot with the listed graphics object.

14. The non-transitory computer-readable storage medium of claim 13, the set of instructions further comprising:
if the magic number of the graphics context is found in the context table:
a third adding code segment for adding the graphics object to the graphics object list such that the graphics object is associated with the graphics context slot wherein the graphics context corresponding to the magic number is stored, and
a discarding code segment for discarding the graphics context from the packet.

15. The non-transitory computer-readable storage medium of claim 14, the set of instructions further comprising:
a fourth adding code segment for adding the magic number of the graphics context to the context table if the magic number of the graphics context is not found among the magic numbers stored in the context table.

16. The non-transitory computer-readable storage medium of claim 13, the set of instructions further comprising:
an applying code segment for applying the graphics context in the graphics context slot of the graphics context storage to draw the graphics objects in the object list that are associated with the graphics context slot.

17. The non-transitory computer-readable storage medium according to claim 13, wherein the instructions are hardware description language (HDL) instructions used for the manufacture of a device.

18. A non-transitory computer-readable storage medium storing a set of instructions for execution by one or more processors to facilitate manufacture of a graphics processing system, the graphics processing system comprising:
a graphics processing unit (GPU), configured to separate a graphics context and graphics object from a command packet;
a context buffer, configured to store the graphics context, the context buffer including graphics context slots;
a graphics object list, configured to store the graphics object, the graphics object list being separate from the context buffer;
a calculator, configured to calculate a magic number of the graphics context, wherein the magic number is an identifier of the graphics context;
a context table for storing the magic number of the graphics context;
wherein the GPU is further configured to:
compare the magic number of the graphics context with magic numbers stored in the context table to determine if the magic number of the graphics context is among the magic numbers in the context table, wherein each magic number corresponds to a specific graphics context;
add the graphics context to a graphics context slot of the context buffer;
add the graphics object to the graphics object list; and
associate the graphics context slot with the stored graphics object, if the magic number of the graphics context is not among the magic numbers in the context table.

19. The non-transitory computer-readable storage medium of claim 18, wherein the GPU is further configured to:
add the graphics object to the graphics object list such that the graphics object is associated with the graphics context slot wherein the graphics context corresponding to the magic number is stored, and
discard the graphics context from the packet, if the magic number of the graphics context is found in the context table.

20. The non-transitory computer-readable storage medium of claim 19, wherein the GPU is further configured to:
add the magic number of the graphics context to the context table if the magic number of the graphics context is not among the magic numbers in the context table.

21. The non-transitory computer-readable storage medium of claim 18, wherein the GPU is further configured to:
apply the graphics context in the graphics context slot of the context buffer to draw the graphics objects in the graphics object list that are associated with the graphics context slot.
